(19) United States
(12) Patent Application Publication
(10) Pub. No.: US 2009/0007720 A1
(43) Pub. Date: Jan. 8, 2009

(54) Protection guard for vehicle handlebar

(75) Inventor: Chien-Tse Tung, Changhua City (TW)

Correspondence Address: BACON & THOMAS, PLLC, 625 SLATERS LANE, FOURTH FLOOR, ALEXANDRIA, VA, 22314-1176, US

(73) Assignee: MOTOSPORTS CORP., CHANGHUA CITY (TW)

(21) Appl. No.: 12/213,810

(22) Filed: Jun. 25, 2008

(30) Foreign Application Priority Data
Jun. 27, 2007 (TW) 96210480

(51) Int. Cl. B62K 21/12

(52) U.S. Cl. 74/551.8

(57) ABSTRACT

A protection guard for vehicle handlebar, which is mounted on a handlebar, includes a fixing arm having an arm body mounted on the handlebar, an arm-to-bracket conjunction portion formed on another end opposite to the handlebar; an adjusting bracket having a bracket body formed of “L” shape, a bracket-to-arm conjunction portion formed on an end of the bracket body, at least two thread holes formed on the bracket-to-arm conjunction portion, a bracket-to-cover joining portion formed on another end, the arm-to-bracket conjunction portion of the fixing arm is threaded to one of the thread holes; and a cover having a cover body, a cover-to-bracket joining portion formed on the cover body and connected to the bracket-to-cover joining portion of the adjusting bracket; thereby, when the adjusting bracket turned around or moved to change the position of the thread hole relative to the arm-to-bracket conjunction portion of the fixing arm, the cover then having variety locating position relative to the handlebar.

### BACKGROUND OF THE INVENTION

1. Field of the Invention

The present invention relates to motorcycle or ATV (All Terrain Vehicle) and more specifically, to a protection guard for vehicle handlebar.

2. Description of the Related Art

A motorcycle or ATV riding on special ground may encounter the hitting of objects, if the objects hitting hands of the rider directly, especially during racing of the motorcycle or ATV, the hands of rider maybe hurt and cannot hold the handlebar and then occur danger or accident, therefore, for safe protection of hands to prevent the objects hitting, the rider usually mounted a cover on each handlebar, using the cover to obstruct the hitting of the objects to hands.

But, after the prior cover mounted on the handlebar, the rider only can adjust the cover mounted on the position of the handlebar, but cannot adjust to another parallel position and/or perpendicular distance of the cover from the handlebar relatively, it is inconvenient and the adjusting position is not enough; therefore, the prior protection guard still can be improved.

### SUMMARY OF THE INVENTION

The main object of the protection guard for vehicle handlebar of the present invention, which providing more wholly protection function of hands of the rider, and further adjusting the position and distance of the cover relative to handlebar variably, to meet the demand of the rider.

To achieve these and other objects of the present invention, the protection guard for vehicle handlebar, which is mounted on a handlebar, comprises a fixing arm having an arm body mounted on the handlebar, an arm-to-bracket conjunction portion formed on another end of the arm body opposite to the handlebar. An adjusting bracket has a bracket body formed of “L” shape, a bracket-to-arm conjunction portion formed on an end of the bracket body, at least two thread holes formed on the bracket-to-arm conjunction portion, a bracket-to-cover joining portion formed on another end of the bracket body, the arm-to-bracket conjunction portion of the fixing arm is threaded to one of the thread holes. And a cover has a cover body, a cover-to-bracket joining portion formed on the cover body and connected to the bracket-to-cover joining portion of the adjusting bracket; thereby, when the adjusting bracket turned around or moved to change the position of the thread hole of the bracket-to-arm conjunction portion relative to the arm-to-bracket conjunction portion of the fixing arm, the cover then having variety locating position relative to the handlebar.

### BRIEF DESCRIPTION OF THE DRAWINGS

FIG. 1 shows an elevational assembly view of a preferred embodiment of the present invention.

FIG. 2 shows an elevational assembly view of the assembly of the fixing arm and adjusting bracket of the preferred embodiment of the present invention.

FIG. 3 shows an elevational explode view of the FIG. 2.

FIG. 4 shows an elevational assembly view of the assembly of the fixing arm and adjusting bracket of the preferred embodiment of the present invention, but showing another adjustment locating position status.

### DETAILED DESCRIPTION OF THE INVENTION

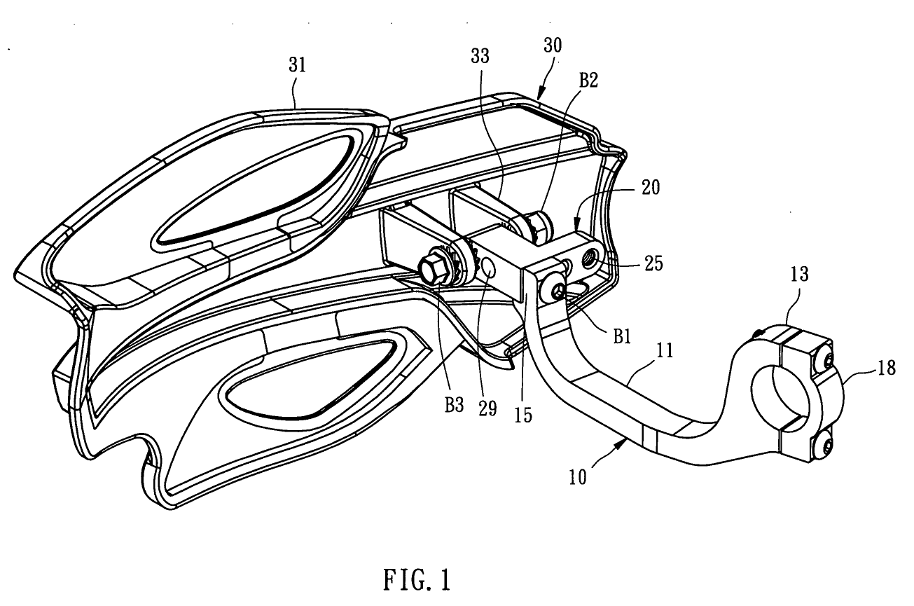

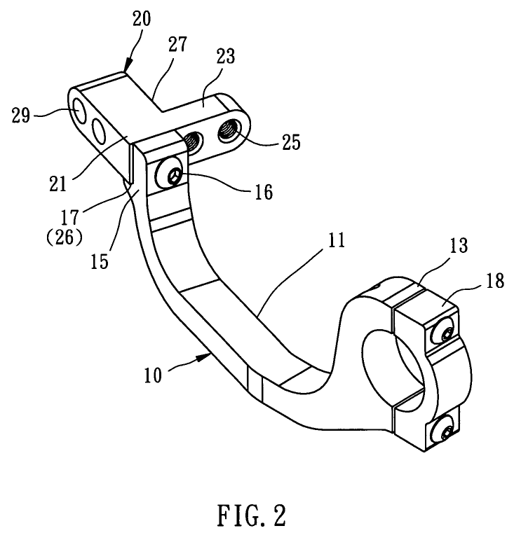

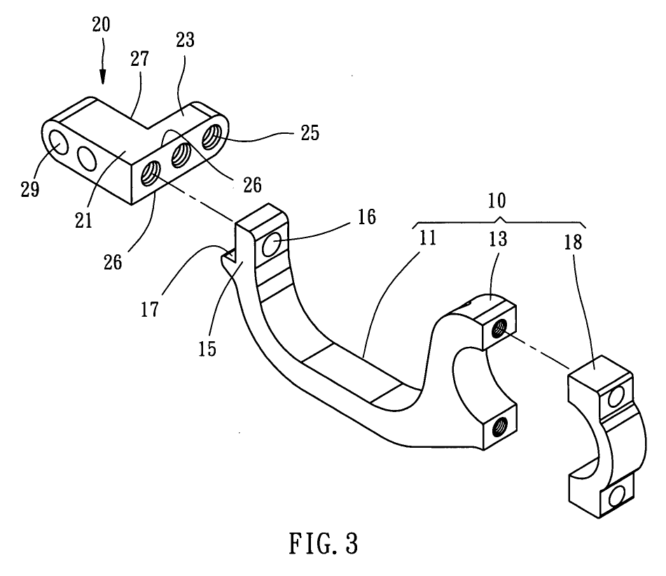

Please refer FIG. 1 to FIG. 4, a protection guard for vehicle handlebar of the preferred embodiment of the present invention, which is mounted on a handlebar (not shown) of a motorcycle (not shown) or ATV (not shown), the protection guard comprises the follows:

A fixing arm 10, which has an arm body 11 formed of arc shape, a bar fixing portion 13 formed at an end of the arm body 11, an arm-to-bracket conjunction portion 15 formed at another end opposite to the bar fixing portion 13 of the arm body 11, a bolt hole 16 opened through the arm-to-bracket conjunction portion 15, an anti-rotating face 17 extended from the arm-to-bracket conjunction portion 15, a handlebar retainer 18 corresponding the bar fixing portion 13 to let the arm body 11 thread mounted on the handlebar.

An adjusting bracket 20, which has a bracket body 21 of “L” shape, a bracket-to-arm conjunction portion 23 formed at an end of the bracket body 21 and relatively parallel with the handlebar, three thread holes 25 opened from middle line of two lateral sides of the bracket-to-arm conjunction portion 23, two anti-rotating faces 26 formed on upper and lower side of the bracket-to-arm conjunction portion 23, a bracket-to-cover joining portion 27 formed from an end of the bracket body 21 and relatively perpendicular to the handlebar, two bolt holes 29 opened from the bracket-to-cover joining portion 27; in which, the fixing arm 10 using a bolt B1 insert through the bolt hole 16 and threaded with one of the thread holes 25 of the adjusting bracket 20, and the anti-rotating face 17 of the fixing arm 10 supporting one side of the anti-rotating face 26 of the bracket-to-arm conjunction portion 23.

A cover 30, which has a cover body 31 made by plastic material, a cover-to-bracket joining portion 33 mounted on the cover body 31, the cover-to-bracket joining portion 33 has two bolt holes (not shown) which further using a bolt B2 and a nut B3 to connect with one of the bolt holes 29 of the adjusting bracket 20.

Via aforesaid elements, the assembly and operation of the preferred embodiment can be described as follows:

First, after the bar fixing portion 13 and the handlebar retainer 18 of the fixing arm 10 mounted on the handlebar, the arc shape of the arm body 11 of the fixing arm 10 can avoid the interference between the fixing arm 10 and the brake accessory (not shown) which mounted on the handlebar; further, when the arm-to-bracket conjunction portion 15 of the fixing arm 10 threaded to different thread hole 25 of the adjusting bracket 20, the cover 30 then changing it's position relatively parallel with the handlebar.

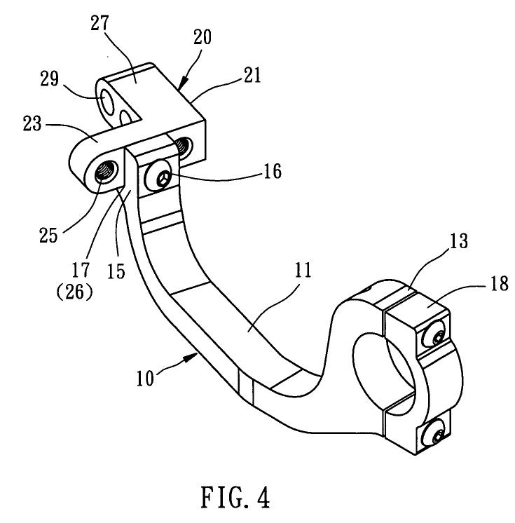

Preferably, although the adjusting bracket 20 only has three thread holes 25, but if let the bracket-to-arm conjunction portion 23 of the adjusting bracket 20 turned around, as shown in FIG. 4, the adjusting bracket 20 then constitute two new positions of the thread holes 25 at another side, that is the adjusting bracket 20 totally having five adjustment positions relatively parallel with the handlebar and providing the mount of the fixing arm 10, then the cover 30 have the adjustment of variable selection of parallel position corresponding to the handlebar; wherein, because each thread hole 25 is formed on the bracket-to-arm conjunction portion 23 of the middle line from up to bottom position, after the adjusting bracket 20 turned around, the anti-rotating face 17 of the fixing arm 10 still stopped against with one of the anti-rotating faces 26 of the adjusting bracket 20.

Further, the cover 30 also may let the bolt hole of the cover-to-bracket joining portion 33 connected with different bolt hole 29 of the adjusting bracket 20, to adjust the distance perpendicular from the cover 30 to the handlebar.

As recited above, the present invention is applied for letting the rider to adjusting variable selection of parallel position and perpendicular distance of the cover 30 relative to the handlebar, and the adjustment is convenient and quickly.

Although the arm body of the fixing arm of the preferred embodiment is formed of arc shape downwards in above embodiment, but for fitting different structure of the handlebar or another cable fitting, the arm body of the fixing arm still can be turned around and then the arc shape is formed upwards.

Except embodiments aforesaid, the cover 30 of the present invention also can mounted on each bolt hole 29 of the adjusting bracket 20 via using a quick release device (not shown), thereby the cover 30 can be mounted on or dismounted from the bracket-to-cover joining portion 27 of the adjusting bracket 20 more quickly, it is needed that this application for changing parts of racing motorcycle or ATV more quickly and conveniently.

Concluding description of aforesaid embodiment, the protection guard for vehicle handlebar of the present invention via the variable assemble position of the fixing arm, adjusting bracket and the cover, let the rider conveniently adjusting the parallel position and perpendicular distance of the cover relative to the handlebar, the present invention not only providing the wholly protection function of hands of the rider, but also further providing variety locating position of the cover relative to handlebar, to meet the demand of the rider.

What is claimed is:

1. A protection guard for vehicle handlebar, which is mounted on a handlebar, the protection guard comprising:
a fixing arm having an arm body mounted on the handlebar, an arm-to-bracket conjunction portion formed on another end of the arm body opposite to the handlebar;
an adjusting bracket having a bracket body formed of “L” shape, a bracket-to-arm conjunction portion formed on an end of the bracket body, at least two thread holes formed on the bracket-to-arm conjunction portion, a bracket-to-cover joining portion formed on another end of the bracket body, the arm-to-bracket conjunction portion of the fixing arm is threaded to one of the thread holes; and
a cover having a cover body, a cover-to-bracket joining portion formed on the cover body and connected to the bracket-to-cover joining portion of the adjusting bracket; thereby, when the adjusting bracket turned around or moved to change the position of the thread hole of the bracket-to-arm conjunction portion relative to the arm-to-bracket conjunction portion of the fixing arm, the cover then having variety locating position relative to the handlebar.

2. The protection guard for vehicle handlebar as claimed in claim 1, wherein the arm body of the fixing arm formed of arc shape downwards.

3. The protection guard for vehicle handlebar as claimed in claim 1, wherein the arm body of the fixing arm upwards formed of arc shape.

4. The protection guard for vehicle handlebar as claimed in claim 1, wherein the bracket-to-arm conjunction portion of the adjusting bracket is and relatively parallel with the handlebar.

5. The protection guard for vehicle handlebar as claimed in claim 1, wherein the bracket-to-cover joining portion of the adjusting bracket is perpendicular to the handlebar relatively.

6. The protection guard for vehicle handlebar as claimed in claim 1, wherein the adjusting bracket further has a plurality of bolt holes opened through the bracket-to-cover joining portion and connected with the cover-to-bracket joining portion of the cover.

7. The protection guard for vehicle handlebar as claimed in claim 6, wherein the cover can be quickly mounted on or dismounted from the bolt hole of the bracket-to-cover joining portion of the adjusting bracket by a quick release device.
